(19) United States
(12) Patent Application Publication
(10) Pub. No.: US 2015/0209213 A1
(43) Pub. Date: Jul. 30, 2015

(54) WEARABLE CRUTCHES

(71) Applicant: Larry Paul KLINE, Ojai, CA (US)

(72) Inventor: Larry Paul KLINE, Ojai, CA (US)

(21) Appl. No.: 14/603,450

(22) Filed: Jan. 23, 2015

Related U.S. Application Data
(60) Provisional application No. 61/931,252, filed on Jan. 24, 2014.

(51) Int. Cl. A61H 1/02; A61H 3/02

(52) U.S. Cl. CPC A61H 1/0292; A61H 3/02

(57) ABSTRACT

A wearable crutches device in its primary form has an adjustable belt to which two adjustable length and pivoting crutches are affixed on each side. When the belt is worn around a person's waist, the tops of the crutches make contact with the wearers armpits. A wearable crutches device in its secondary form has an articulated device attached to the bottom of one or both sides of the primary form of the invention. The articulated device consists of two adjustable length metal tubes connected end to end with a flexible joint and which attaches to the sides of the wearers leg(s), the bottom of which comes in contact with the walking surface when standing or walking.

This application claims priority to U.S. Provisional Application No. 61/931,252 filed Jan. 24, 2014, the entirety of which is incorporated by reference herein.

### FIELD OF THE INVENTION

The present invention is in the technical field of Physical Medicine Devices. More particularly, the present invention is in the technical field of Physical Medicine Prosthetic Devices. More particularly, the present invention is in the technical field of crutches.

### BACKGROUND OF THE INVENTION

For reducing the amount of compression on an individual's lower spine and to maintain that reduction of compression, conventional crutches are effective only while an individual stands still in one position. Moving one's body forward with conventional crutches requires that at least one foot repeatedly contacts the walking surface, resulting in a recompression of the spine with each step.

Numerous types of devices have appeared as belts with short crutches attached to either side of the belt and terminating at each armpit to reduce the amount of compression on an individual's lower spine. A common aspect of each of these devices is adjustability in the height of each of the side crutches to vary the amount of spinal decompression and concurrent amount of pressure on the wearer's armpit areas. No currently known device is constructed in a manner that dynamically adjusts the length of the side crutches either without any action required from the wearer, or with a simple action from the wearer while the device is being worn.

For reducing the amount of compression on an individual's hips, and/or knees, and for ankles, and to maintain that reduction of compression, conventional crutches are effective only while an individual stands still in one position. Also, traditional crutches are bulky, cannot be used hands-free, are difficult to transport and cannot be concealed while in use.

Numerous types of hands-free crutches have appeared as monopod or bipod devices that attach to the user's thigh region on a single leg to facilitate forward movement for individuals with impaired lower extremity functions that require an individual to exert little or no pressure on the knee and/or ankle joints. (For example. see U.S. Pat. No. 2,827,897 and U.S. Publication No. 2013/0152986 A1). In the case of hands free crutches, the known devices are bulky and require either attached monopods or that the user's knee be positioned in an approximately 90-degree angle.

Exoskeleton devices have appeared that attach to the user's upper body and lower limbs (in total or in part, such as the knee) to help persons with impaired hip(s) or impaired lower extremity function in one or both legs walk. (See for example. International Publication. Nos. WO 2014/093470 A1 and WO 2014/164804 A1). in the case of exoskeleton devices, they are designed to move the wearer's legs, rather than the wearer using their own muscles to move their legs.

There is therefore a need for an improved wearable crutch that will overcome the deficiencies of the prior art devices.

### SUMMARY OF THE INVENTION

The primary form of the present invention is a pair of crutches that are attached to the sides of an adjustable belt worn between an individual's waist and hips, continuously reducing compression of the spine while the wearer is standing, sitting, walking, bending or twisting. It can operate hands-free and can be worn under loose fitting clothes.

The alternate form of the present invention consists of an embodiment of the primary form of the device with the addition of an articulated crutch leg that connects to the lower part of one or both sides of the primary form of the device, is connected to the wearer's knee or knees and ankle or ankles with straps and which extends to the walking surface, continuously reducing compression of the hips, knees and ankles while the wearer is standing or walking.

### BRIEF DESCRIPTION OF THE DRAWINGS

FIG. 1 is a perspective view of the preferred embodiment of the present invention in its primary form.

FIG. 2 is a perspective close-up view of the lower strut assembly of the present invention in its primary form.

FIG. 3 is a perspective view of a second, alternate embodiment of the present invention in its primary form.

FIG. 4 is a perspective close-up view of the design for the traction adjustment assembly.

FIG. 5 is a perspective view of a third, alternate embodiment of the primary form of the present invention to which the articulated crutch of FIG. 6 is attached, together forming the secondary form of the present invention.

FIG. 6 is a perspective view of the articulated crutch leg that can be connected to a third, alternate embodiment of the primary form of the present invention as shown in FIG. 5, together forming the secondary form of the present invention.

FIG. 7 is a perspective close-up view of the folding handle component of the articulated crutch leg.

FIG. 8 is a perspective close-up view of the knee joint and knee support components of the articulated crutch leg.

FIG. 9 is a detailed view of he knee joint assembly of the articulated crutch leg.

FIG. 10 is a perspective close up view of an alternate design of the knee joint and knee support components of the articulated crutch leg.

### DETAILED DESCRIPTION OF THE INVENTION

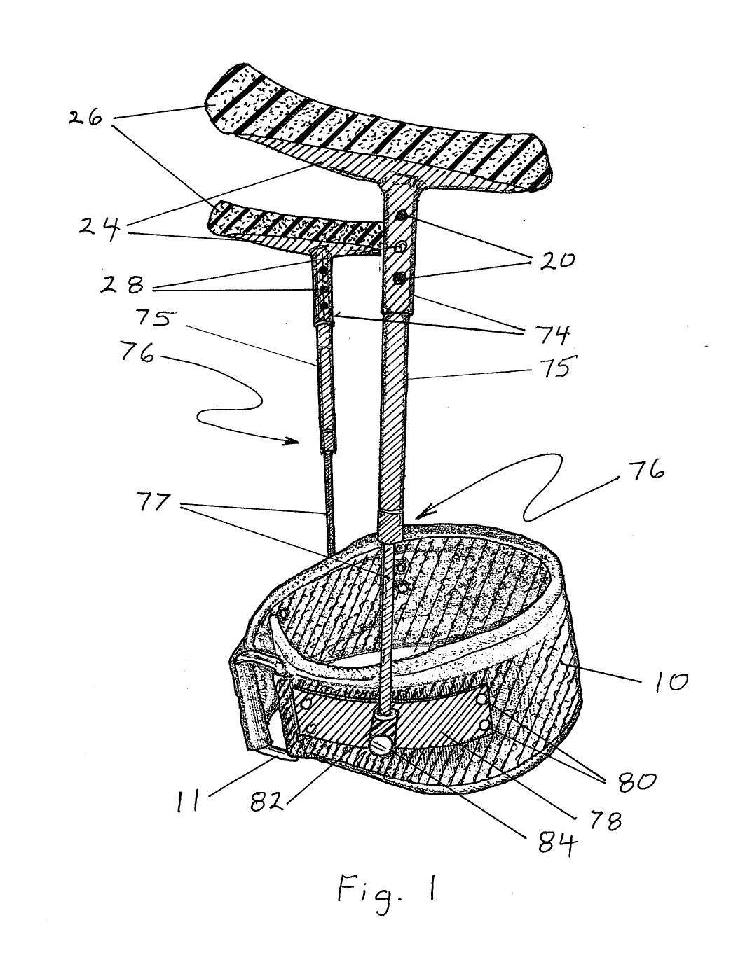

Referring now to the preferred embodiment of the invention in more detail, in FIG. 1 there is shown a padded belt 10 with two attached crutch assemblies, each consisting of an upper strut 74 and a lower strut assembly 76.

The belt 10 is adjusted for various waist sizes by sliding the free end of the belt through the attached metal loop 11 and pulling it to varying degrees of tightness around the waist. The free end of the belt 10 has Velcro® cloth attached to one side, and it is held firmly in the desired position by pressing the Velcro® side of the belt's free end to the Velcro® cloth which is attached to the front section of the belt.

Each upper strut 74 consists of a hollow tube to which a cross piece 24 is attached at the top. Each cross piece 24 is covered with a removable pad 26. Each upper strut 74 has four 5/16″ holes 20 on opposing sides of the top portion of the hollow tube. Each lower strut assembly 76 consists of a hollow cylinder 75 fillable with a fluid such as nitrogen gas and a solid piston rod 77 that moves up and down within the hollow, gas-filled cylinder without allowing the gas to escape. Built into opposing sides of the portion of each lower strut assembly 76 that is just above the nitrogen-filled cylinder 75 are two, fixed-position spring loaded pins 28. The top section of each lower strut assembly 76 snugly slides into the bottom of each upper strut 74. The two, fixed position spring loaded pins 28 on each lower strut assembly 76 protrude through a pair of holes 20 in each upper strut 74, holding each upper strut 74 and lower strut assembly 76 pair in locked positions.

A lower strut mounting plate 78 is attached to each side of the belt 10 by four rivets 80. Each lower strut mounting plate 78 has a hollow pocket 82 formed in the middle section of the mounting plate 78. Each pocket 82 has a top opening and a transverse hole in the lower portion of the pocket 82. At the bottom end of each solid piston rod 77 is a hole extending transversely through the rod 77.

Each lower strut assembly 76 is attached to the belt 10 by sliding the solid piston 77 into the lower strut mounting plate pocket 82, aligning the transverse hole at the end of each piston rod 77 with the hole in the mounting plate pocket 82 and passing a permanent fastener 84 through the two holes. The fastener 84 thus pivotally mounts the lower strut assembly 76 to the mounting plate 78.

In more detail, still referring to the invention of FIG. 1, relative to the position of the tightened belt 10 that ideally rests on a wearer's hips, the height of each upper strut 74 can be adjusted by pressing inward on the two spring loaded pins 28 that protrude through a pair of upper strut holes 20, thus allowing the upper portion of the lower strut assembly 76 to slide up and down the length of the upper strut 74 to the height and position that provides the wearer with sufficient transfer of upper body weight from the spine and hips to the belt 10. Additional upper strut 74 height adjustments will be achieved automatically and dynamically by the motion of the lower strut piston rod 77 within the nitrogen gas filled cylinder 75. When attached to the lower strut mounting plate 78, each lower strut assembly 76 pivots about the fastener 84 relative to the belt 10 and therefore rotates forward and backwards in a range that provides the wearer with continuous transfer of upper body weight from the spine to the belt 10 while engaged in various body positions and types of movement, including standing, walking, sitting, bending and twisting. The gas filled cylinder 75 maintains a constant traction in all positions of extension or compression.

In further detail, still referring to the invention of FIG. 1, the belt 10, which can be created in small, medium, large and extra-large sizes to fit wearers with a range of waist sizes, is lightweight and has adequate padding to provide each wearer with belt 10 tightness options to deliver functionality while also providing reasonable comfort. The belt 10 is sufficiently wide, durable and resilient to twist minimally while absorbing the weight of the upper body while in use. The upper strut 74 is both durable and lightweight. The various locked positions of the upper strut 74 and lower strut assembly 76 provide sufficient adjustment to fit wearers with a range of torso lengths. The removable pad 26 on the upper strut 74 fits snugly over the cross piece 24 and is sufficiently durable and pliable to withstand continuous pressure and shifting, while minimizing discomfort in the wearer's arm pit area.

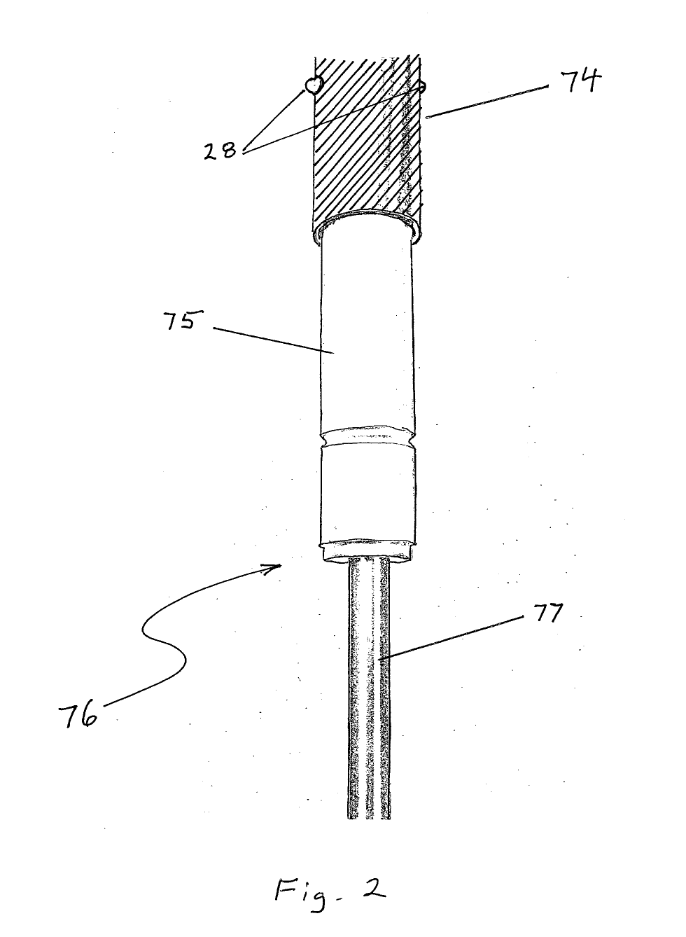

Referring now to FIG. 2, there is shown a close-up perspective of the design for the lower strut assembly 76, showing the hollow cylinder 75 filled with nitrogen gas and a solid piston rod 77 that moves up and down within the hollow, gas-filled cylinder without allowing the nitrogen gas to escape. Built into opposing sides of the portion of each lower strut assembly 76 that is just above the nitrogen-filled cylinder 75 are two, fixed-position spring loaded pins 28 that hold the lower crutch assembly in place within the upper strut 74.

The construction details of the invention as shown in FIGS. 1 and 2 are that the belt 10 may be made of nylon webbing or of any lightweight, flexible and strong material. The belt 10 inner padding may be made of nylon webbing or any lightweight, flexible and strong material for the outer shell wrapped around a pad made of polyethylene vinyl acetate or any lightweight, soft and durable material. The upper strut 74 and lower strut assembly 76 may be made of aluminum or of any lightweight, rigid and strong material. The removable pad 26 may be made of any soft, pliable and durable material. Further, the various components of the present invention can be made of different materials.

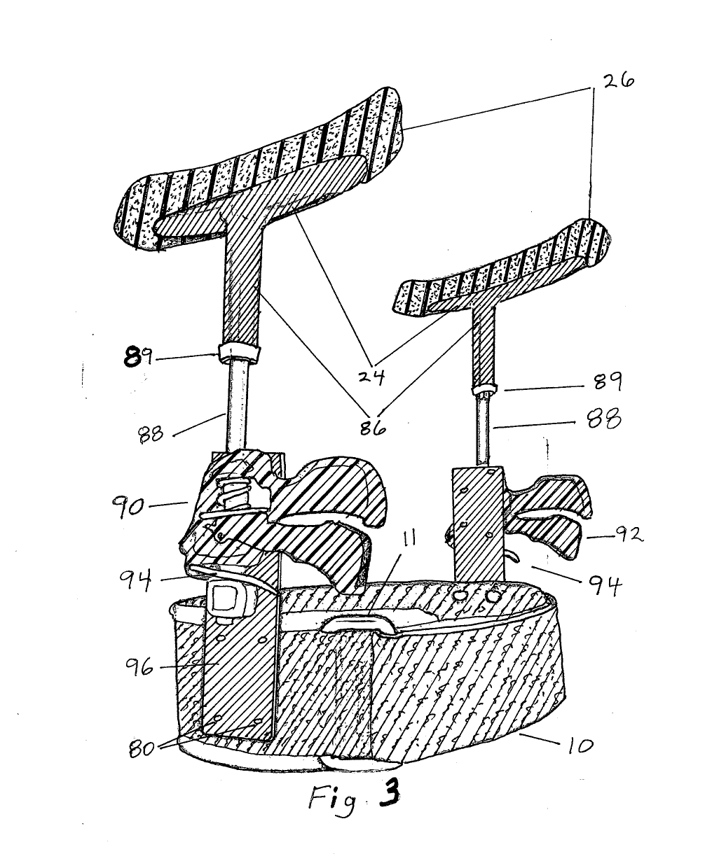

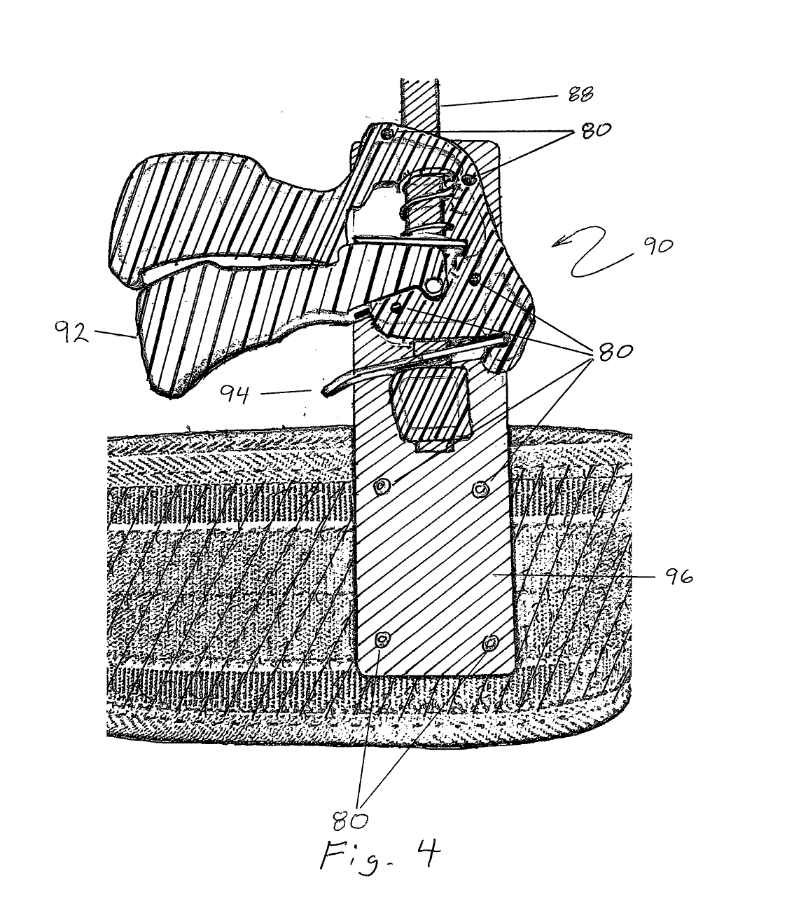

Referring now to FIGS. 3 and 4, there is shown an alternate embodiment of the present invention in its primary form, the difference from the preferred embodiment being the design of the crutch assembly.

Each upper strut 86 consists of a hollow tube to which a cross piece 24 is attached at the top. Each cross piece 24 is covered with a removable pad 26. Each lower strut 88 consists of a solid rod that is threaded on the top end and has a series of notches along the lower portion of each lower strut 88. The top section of each lower strut 88 snugly slides into the bottom of each upper strut 86, and the position of each lower strut 88 relative to each upper strut 86 is fixed by tightening a nut 89 on the threaded portion of the lower strut 88.

Each lower strut 88 has a series of notches or grooves along the lower portion of the strut 88 that form a part of a ratchet mechanism. Attached to each side of the belt 10 is a traction adjustment assembly 90 which consists of a metal plate 96, a pair of traction increase levers 92, and a traction release lever 94. Each metal plate 96 is attached to each side of the belt 10 with rivet fasteners 80. The traction increase levers 92 and the traction release lever 94 are pivotally attached in any suitable manner to the portion of each metal plate 96 that protrudes above the belt 10. The lower strut 88 slides snugly between the top of the metal plate 96 and the traction adjustment assembly 90.

Referring now to FIG. 4, there is a close-up perspective showing more details of the design for the traction adjustment assembly 90. The construction of each traction adjustment assembly 90 allows the notches in the lower portion of each lower strut 88 to engage firmly with each traction increase lever 92 so that by squeezing the handles of the traction increase levers 92, the crutch assembly moves vertically and is locked firmly in position. The pressing of each traction release lever 94 disengages the notches in the lower strut 88 from the traction adjustment assembly 90, consequently allowing the crutch assembly to slide downward and be adjusted after which the lever 94 is moved back into a locked position.

The construction details of the invention as shown in FIGS. 3 and 4 are that the traction adjustment assembly 90 may be made of hard plastic and metal. Further, the various components of the present invention can be made of different materials.

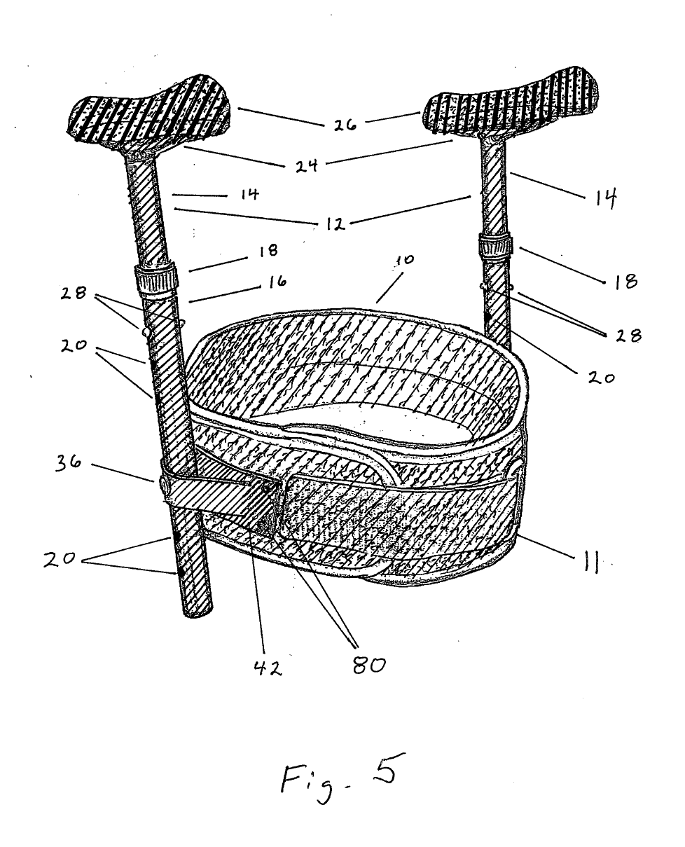

Referring now to FIG. 5, there is shown a third variation of the invention in its present form that is a specific design for use with the articulated crutch. In this FIG. 5 there is shown a padded belt 10 with two attached crutch assemblies 12, each consisting of an upper strut 14 and a lower strut 16.

The belt 10 is adjusted for various waist sizes by sliding the free end of the belt through the attached metal loop 11 and pulling it to varying degrees of tightness around the waist. The free end of the belt 10 has Velcro® cloth attached to one side, and it is held firmly in the desired position by pressing the Velcro® side of the belt's free end to the Velcro cloth which is attached to the front section of the belt.

For each crutch assembly 12, the upper strut 14 snugly fits inside the lower strut 16, permitting the upper strut 14 to slide up and down the length of the lower strut 16. Each lower strut 16 has a threaded ferrule 18 at the top and is combined with two opposed, fixed-position spring loaded pins 28 movable into selected holes 20 aligned along its length on one side of the lower strut 16. Each hole 20 that is aligned along one side of the lower strut 16 has an opposing hole that is 180 degrees on the other side of the lower strut 16 and that is at the same distance the hole 20 is from the bottom of the lower strut 16. Each upper strut 14 has a cross piece 24 at the top that is covered with a removable pad 26. The two fixed position spring-loaded pins 28 protrude through any pair of lower strut holes 20, and that with the tightened threaded ferrule 18, hold upper strut 14 and lower strut 16 in a fixed position. The upper strut 14 fitted together with the lower strut 16 forms the crutch assembly 12. A lower strut mounting plate 42 is attached to each side of the belt 10 by four rivets 80. The lower strut 16 is attached to opposite sides of the belt 10 via a fastener assembly 36 that passes through a hole in the metal plate 42 and any pair of lower strut holes 20 near the bottom of the lower strut 16. The fastener assembly 36 consists of an elevator bolt, a self-locking nut, two metal washers between the inside of the locking nut and the lower strut 16, and two plastic washers between the lower strut 16 and the belt 10.

In more detail, still referring to the invention of FIG. 5, relative to the position of the tightened belt 10 that ideally rests on a wearer's hips, the height of each crutch assembly 12 can be adjusted by first loosening the threaded ferrule 18 at the top of the lower strut 16, and then pressing inward on the two spring loaded pins 28 that protrude through a pair of lower strut holes 20, thus allowing the upper strut 14 to slide up and down within the lower strut 16 to the height and position that provides the wearer with sufficient transfer of upper body weight from the spine and hips to the belt 10. Additional crutch assembly 12 height adjustments can be achieved by selecting a different pair of lower strut holes 20 through which to pass and tighten the fastener assembly 36. When attached to the fastener assembly 36, each crutch assembly 12 pivots relative to the belt 10 and therefore rotates forward and backwards in a range that provides the wearer with continuous transfer of upper body weight from the spine to the belt 10 while engaged in various body positions and types of movement, including standing, walking, sitting, bending and twisting.

In further detail, still referring to the invention of FIG. 5, the belt 10, which can be created in small, medium, large and extra-large sizes to fit wearers with a range of waist sizes, is lightweight and has adequate padding to provide each wearer with belt 10 tightness options to deliver functionality while also providing reasonable comfort. The belt 10 is sufficiently wide, durable and resilient to twist minimally while absorbing the weight of the upper body while in use. The crutch assembly 12 is both durable and lightweight. In combination with various locked positions of the upper strut 14 and positions to which the lower strut 16 is attached to the belt 10, the lower strut 16 is of sufficient length to fit wearers with a range of torso lengths, while not being so long as to come in contact with any typical surface on which a wearer may be seated. The removable pad 26 on the upper strut 14 fits snugly over the cross piece 24 and is sufficiently durable and pliable to withstand continuous pressure and shifting, while minimizing discomfort in the wearer's arm pit area.

The construction details of the invention as shown in FIG. 5 are that the belt 10 may be made of nylon webbing or of any lightweight, flexible and strong material. The belt 10 inner padding may be made of nylon webbing or any lightweight, flexible and strong material for the outer shell wrapped around a pad made of polyethylene vinyl acetate or any lightweight, soft and durable material. The crutch assembly 12 upper struts 14 and lower struts 16 may be made of aluminum or of any lightweight, rigid and strong material. The removable pad 26 may be made of any soft, pliable and durable material.

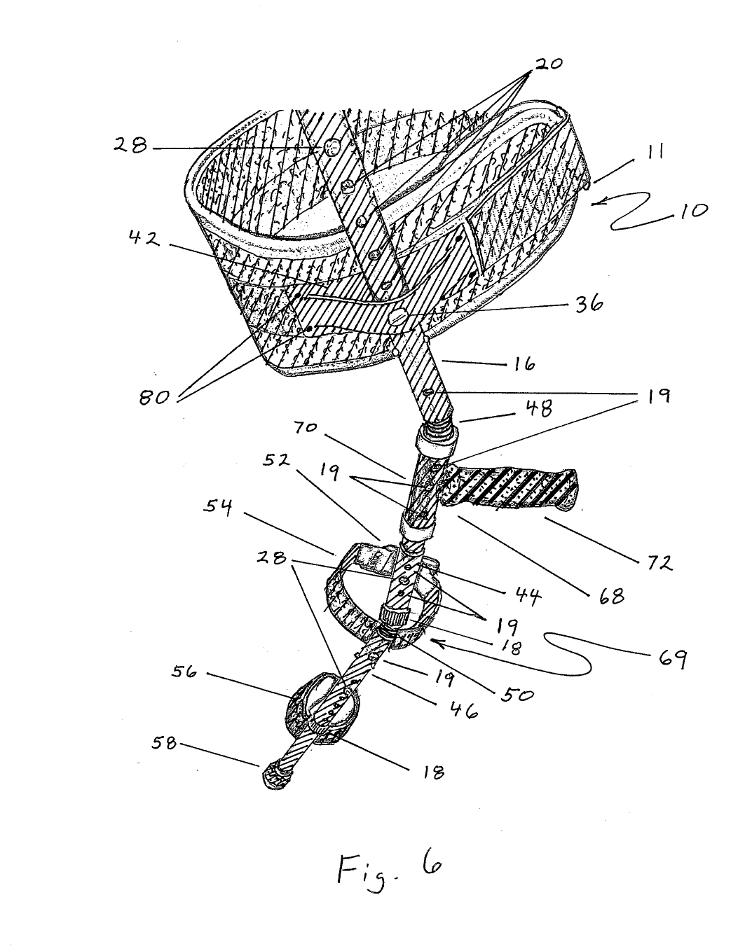

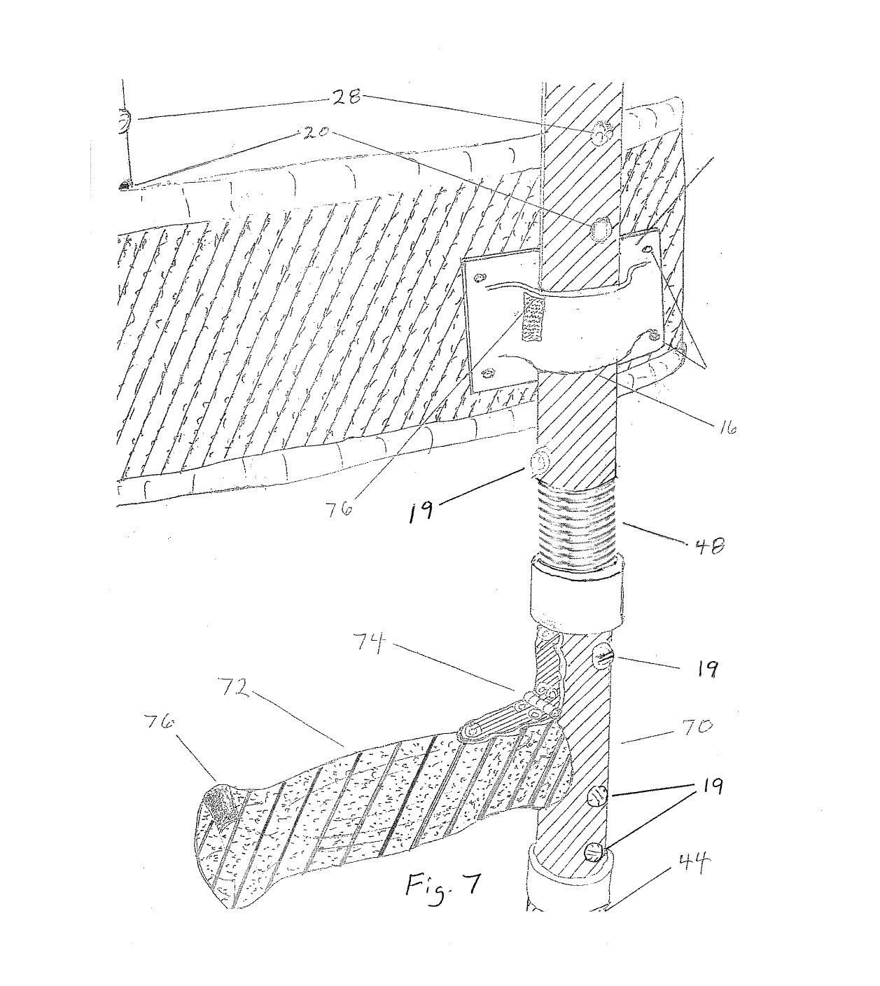

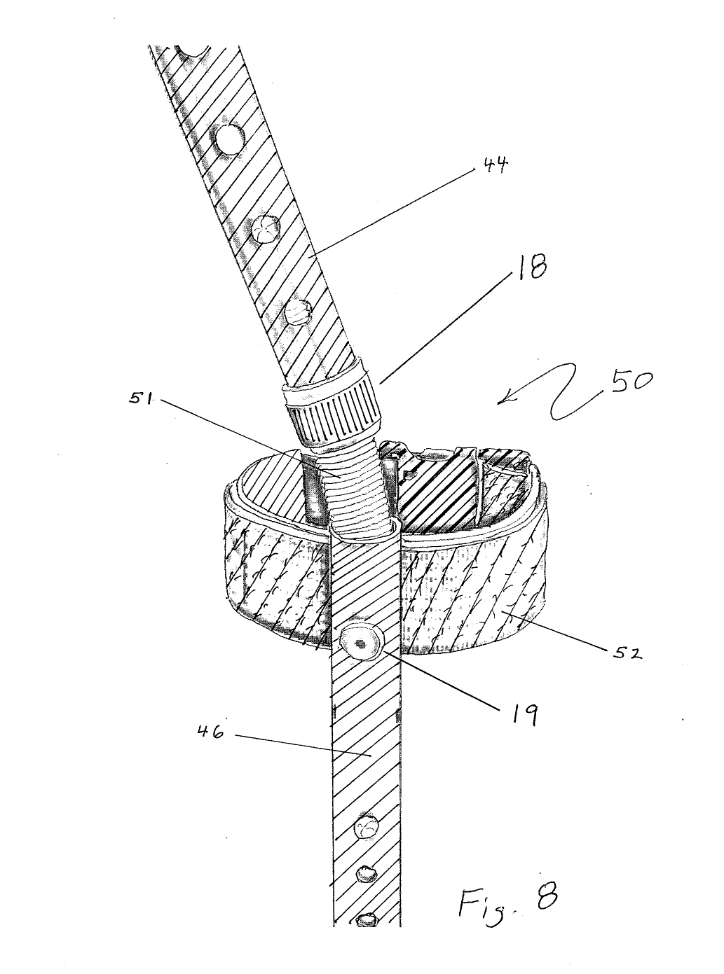

Referring now to FIGS. 6 through 9, in this secondary form of the present invention, an articulated crutch leg assembly 69 is connected to the variation of the present invention in its primary form as depicted in FIG. 5. The articulated crutch assembly 69 consists of a folding handle assembly 68 (see FIG. 7), a two-piece upper strut 44, a two-piece lower strut 46, and a knee joint assembly 50 (see FIG. 8) that connects the upper strut 44 to the lower strut 46. The folding handle assembly 68 connects to the bottom of the crutch assembly lower strut 16 via a spring joint assembly 48. The top end of the upper strut 44 is inserted into the bottom of the folding handle assembly 68 tube 70 and secured in place via a machine screw 19. The bottom end of the upper strut 44 is connected to the top end of the knee joint assembly 50. The top end of the lower strut 46 is connected to the bottom end of the upper strut 44 via the insertion of the knee joint assembly 50 into the ends of the upper strut 44 and lower strut 46. The knee joint assembly 50 is held in place within the lower strut 46 by a machine screw 19. An adjustable knee strap 52 is permanently attached to the leg-side surface of the lower strut 46 in proximity to the knee joint assembly 50, and an adjustable ankle strap 56 is permanently attached to the leg-side surface of the lower strut 46. The lower strut 46 terminates with the crutch tip 56, which fits snugly over the bottom of the lower strut 46.

In more detail, still referring to the secondary form of the invention of FIGS. 6 and 7, the vertical portion of the folding handle assembly 68 is a metal tube 70 the top end of which is connected to the bottom of the crutch assembly lower strut 16 via the insertion of a spring joint assembly 48 into the ends of the crutch assembly lower strut 16 and the metal tube 70. The spring joint assembly 48 is held in place by machine screws 19 in the crutch assembly lower strut 16 and the metal tube 70. The metal tube 70 has extending outwardly from it a padded handle 72. A folding handle grip 72 is slid over a metal tube and is attached to the lower section of the folding handle tube 70 via a heavy duty hinge 74, allowing the folding handle grip 72 to be moved to a position that is adjacent and parallel to the folding handle tube 70 and held in place by any suitable means such as Velcro®. Connected to the lower end of folding handle assembly 68 metal tube 70 and held in place by two machine screws 19 is the two-piece upper strut 44 portion of the articulated crutch leg assembly 69.

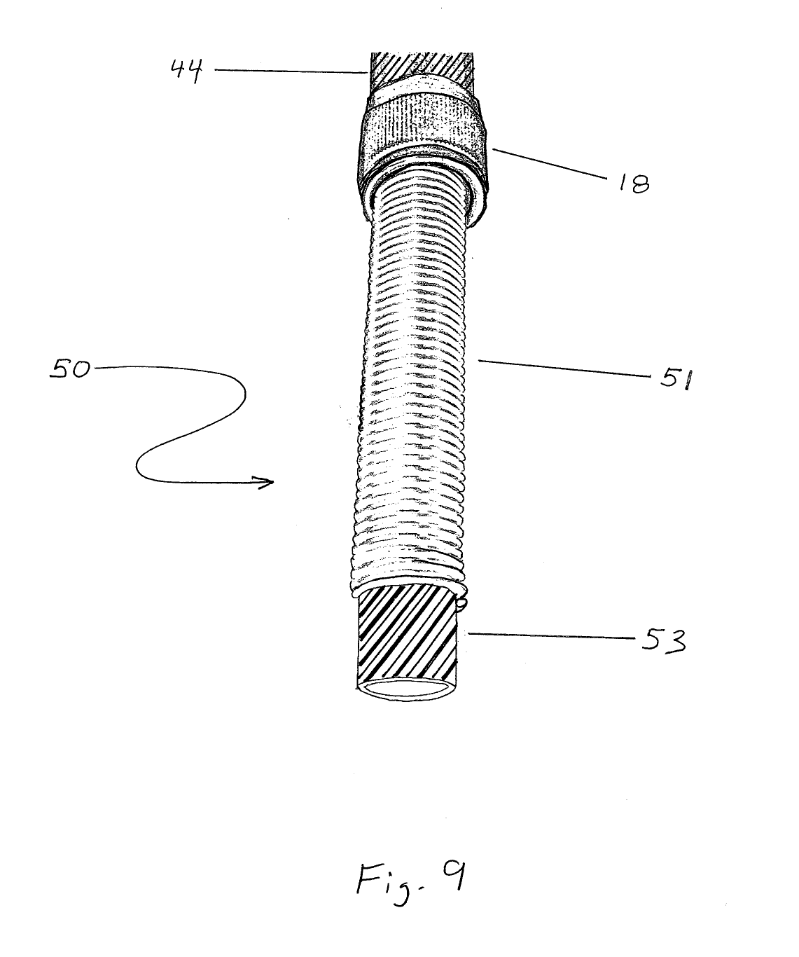

in more detail, still referring to the secondary form of the invention of FIGS. 6 through 9, the construction and dimensions of the spring joint assembly 48 are such that will provide a reliable and flexible connection between the crutch assembly lower strut 16 and the folding handle assembly 68, enabling the device to provide continuous decompression of the hip joint while the wearer moves the body while standing, walking or sitting. The adjustable knee strap 52 firmly holds the lower strut 46 against the wearer's upper calf. As is best seen in FIG. 8, the length and tightness of the knee strap 52 is adjusted by sliding one end of the knee strap 52 through a suitable well-known plastic clip 53. A1-½″ to 2″ inches wide padded knee brace 54 is permanently attached to the upper strut 46 over the leg-side surface of the knee strap 52. The padded knee brace 54 in combination with the knee strap 52 provides continuous alignment between the wearer's calf and the lower strut 46, minimizing lateral movement of the knee joint assembly 50 from the wearer's leg. The length of the upper strut 44 is adjusted by sliding the two pieces of the upper strut 44 to the desired total length of the upper strut 44 and securing the desired length by engaging a pair of spring loaded pins 28 protruding through a pair of matched holes 20 in the upper strut 44. As is best seen in FIG. 9, the knee joint assembly 50 is constructed to simulate the non-twisting movement of the wearer's knee. At the bottom of the lower strut 46 is a rubber foot 58 that performs the same function as the foot of a standard crutch, absorbing all of the wearer's lower body weight between the belt 10 and the wearer's foot, allowing for decompression of the hip joints, knee joints and ankle joints. The adjustable ankle strap 56 comfortably holds the lower strut 46 against the wearer's ankle, providing continuous alignment between the wearer's lower leg and the lower strut 46, minimizing lateral movement of the lower strut 46 from the wearer's lower leg. The adjustable ankle strap 56 consists of a strap and a two piece plastic clip as commonly used on backpacks. The length and tightness of the ankle strap 56 is adjusted by sliding one end of the ankle strap 56 through the plastic clip. The length of the lower strut 46 is adjusted by loosening the threaded ferrule 18 and sliding the two pieces of the lower strut 46 to the desired total length of the lower strut 46 and securing the desired length by engaging a pair of spring loaded pins 28 protruding through a pair of matched holes 20 in the lower strut 46.

The construction details of the secondary form of the invention of FIGS. 6 through 9 are that the upper strut 44 and lower strut 46 may be made of aluminum or of any lightweight, rigid and strong material. The folding handle assembly metal tube 70 may be made of aluminum or any lightweight, rigid and strong material. The folding handle assembly grip 72 may be made of any plastic material that has a feel and functionality similar to grips on standard walkers. The heavy duty hinge 74 may be made of steel or any rigid and durable metal. The spring joint assembly 48 and knee joint assembly 50 are comprised of a heavy duty steel coil spring 51 inside of which is inserted a section of flexible plastic tubing 53. The adjustable knee strap 52 and adjustable ankle strap 56 are made of nylon webbing or any lightweight, flexible and strong material and are each combined with a two piece plastic clip as commonly used on backpacks. The padded knee brace 54 may be made of any flexible spring metal material. A dense foam padding is adhered to the inside surface of the padded knee brace 54. The crutch tip 58 may be made of the same or similar materials as tips on standard crutches. Further, the various components of the present invention can be made of different materials.

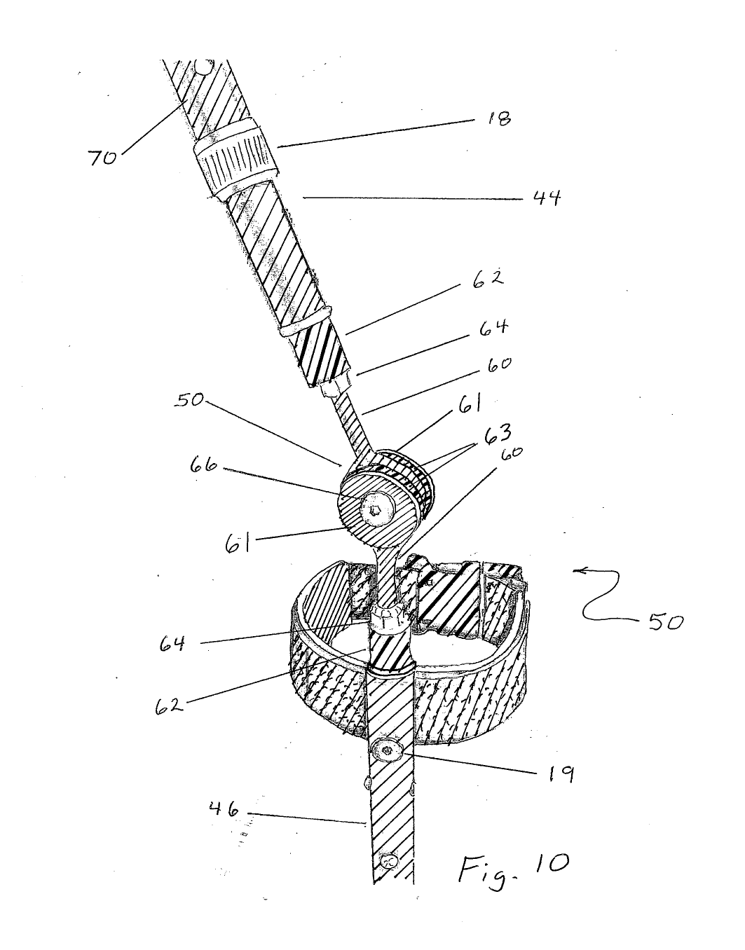

Referring now to FIG. 10, there is shown a close-up perspective of an alternate design for the articulated crutch leg's knee joint assembly 50. The threaded ends of two steel eye bolts 60 are screwed into the ends of two metal tubes 62 and tightened against the bottom of the metal tubes 62 with threaded nuts 64. The two eye bolts 60 are then connected together in the following manner. Two metal compression washers 61 are placed over the holes on the outer surface of each of the eye bolts 60. Two firm rubber grommets 63 are inserted tightly into the holes of the eye bolts 60. The two eye bolts 60, the two metal washers 61 and the two grommets 63 are held together by an elevator bolt and nut 66. The ease of scissors type movement of the two eye bolts 60 is regulated by the tightness of the elevator bolt and nut 66. The two metal tubes 62 are then inserted into the end of the upper strut 44 and lower strut 46 and tightened in place with threaded ferrules 18.

The construction details of the knee joint assembly of FIG. 10 are that the metal tubes 62 may be made of any rigid and strong metal. The eye bolts 60, threaded nuts 64, elevator bolt and nut 66 and metal washers may be made of steel or any strong metal. The grommets 63 may be made of any strong and durable rubber-like material. Further, the various components of the present invention can be made of different materials.

The advantages of the present invention in its primary form include, without limitation, that it continuously and dynamically reduces compression of the wearer's spine while sitting, walking, standing and while bending or twisting the upper body in each of those three modes. Conventional crutches can provide comparable reduction of spine compression only while standing in one position. The device reduces spine compression unobtrusively when worn under loose fitting clothing and leaves the wearer's hands completely free. Unlike conventional crutches, the device is easy to transport and store. Unlike other devices designed to reduce spine compression for wearers who are sitting, standing or in motion, the present invention dynamically adjusts the length of the side crutches, and consequently the amount of pressure on the armpit areas, either without any action required from the wearer or with a simple action from the wearer while the device is being worn.

The advantages of the present invention in its secondary form include, without limitation, that it continuously reduces compression of the wearer's spine, and one or both hips, knees and ankles while sitting, walking, standing and while bending or twisting the upper body in each of those three modes. Conventional crutches can provide comparable reduction of hip, knee and ankle compression only on one side of the body, because the other leg on the other side of the body must touch the walking surface when standing or moving. Conventional crutches cannot be utilized hands-free. Other hands-free crutches are bulky and cannot be worn relatively unobtrusively. Exoskeleton devices do not allow the wearer to utilize their own muscles while moving. The present invention in its secondary form reduces spine and joint compression unobtrusively when worn under loose fitting clothing and leaves the wearer's hands completely free. Unlike conventional crutches, the device is easy to transport and store.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. Wearable crutches for continuously reducing compression of the user's spine while the user is standing, sitting, walking, bending or twisting, the crutches comprising:
a wide adjustable in length belt adapted to be worn by the user and surrounding the user from side to side between the user's waist and hips, and
a pair of crutch assemblies combined with the belt, one assembly on each side of the belt, each crutch assembly comprising:
a mounting plate affixed to the belt;
a support member having an upper strut and a lower strut, the upper strut providing a fluid cylinder and the lower strut having a piston moveable in the cylinder;
the lower strut being affixed to the mounting plate; and
a cross member combined with the upper strut and adapted to accommodate the user's arm pit;
whereby the crutches dynamically reduce compression of the user's spine without any action required from the user while using the crutches.

2. The wearable crutches of clam I in which the lower strut is pivotally affixed to the mounting plate.

3. The wearable crutches of claim 1 in which the cross member is T-shaped with a cross piece and a downwardly extended adjustment member, a portion of the upper strut above the cylinder being combined with the adjustment member to provide for a plurality of changeable fixed positions to vary the length of the support member and thereby accommodate users of different heights.

4. The wearable crutches of claim 1 in which there is padding on the top of the cross member to make the crutches more comfortable for the user.

5. Wearable crutches for continuously reducing compression of the user's spine while the user is standing, sitting, walking, bending or twisting, the crutches comprising:
a wide adjustable in length belt adapted to be worn by the user and surrounding the user from side to side between the user's waist and hips, and
a pair of crutch assemblies combined with the belt, one assembly on each side of the belt, each crutch assembly comprising:
a mounting plate affixed to the belt;
a support member having an upper strut and a lower strut;
the lower strut being pivotally affixed to the mounting plate;
the upper strut being combined with the lower strut to provide for a plurality of changeable fixed positions to vary the length of the support member and thereby accommodate users of different heights; and
a cross member combined with the upper strut and adapted to accommodate the user's arm pit;
whereby the crutches dynamically reduce compression of the user's spine without any action required from the user while using the crutches.

6. Wearable crutches for continuously reducing compression of the user's spine while the user is standing, sitting, walking, bending or twisting, the crutches comprising:
a wide adjustable in length belt adapted to be worn by the user and surrounding the user from side to side between the user's waist and hips, and
a pair of crutch assemblies combined with the belt, one assembly on each side of the belt, each crutch assembly comprising:
a mounting plate affixed to the belt;
a support member having an upper strut and a lower strut;
the lower strut being affixed to the mounting plate;
the upper strut being combined with the lower strut to provide for a plurality of changeable fixed positions to vary the length of the support member and thereby accommodate users of different heights;
a traction adjustment assembly combined with the lower strut to increase or decrease the traction of the crutches a selected amount; and
a cross member combined with the upper strut and adapted to accommodate the user's arm pit;
whereby the crutches dynamically reduce compression of the user's spine without any action required from the user while using the crutches.

7. Wearable crutches for continuously reducing compression of the user's spine while the user is standing, sitting, walking, bending or twisting, the crutches comprising:
a wide adjustable in length belt adapted to be worn by the user and surrounding the user from side to side between the user's waist and hips, and
a pair of crutch assemblies combined with the belt, one assembly on each side of the belt, each crutch assembly comprising:
a mounting plate affixed to the belt;
a support member having an upper strut and a lower strut;
the tower strut being affixed to the mounting plate;
the upper strut being combined with the lower strut to provide for a plurality of changeable fixed positions to vary the length of the support member and thereby accommodate users of different heights;
a cross member combined with the upper strut and adapted to accommodate the user's arm pit; and
an articulated crutch assembly combined with the lower strut, said articulated crutch assembly comprising:
a handle assembly pivotally combined with the lower strut and having a handle for grasping by the user; and
a knee joint assembly pivotally combined with the handle assembly, the knee joint assembly having a knee strap and an ankle strap to secure the knee joint assembly to the users leg;
whereby the crutches dynamically reduce compression of the user's spine.

8. The wearable crutches of claim 7 in which the handle is foldable out of he way when not in use.

9. The wearable crutches of claim 7 in which the handle assembly is combined with the lower strut by a spring joint assembly.

10. The wearable crutches of claim 9 in which the knee joint assembly combined with the handle assembly by a spring joint assembly.

11. The wearable crutches of claim 9 in which the knee joint assembly is combined with the handle assembly by a pivot connection having eye bolts connecting the two assemblies.

12. The wearable crutches of claim 7 in which the handle assembly provides for a plurality of selected fixed lengths to vary the length of the handle assembly.

13. The wearable crutches of claim 12 in which the knee joint assembly provides for a plurality of selected fixed lengths to vary the length of the knee joint assembly.
